(19) United States
(12) Patent Application Publication
(10) Pub. No.: US 2009/0196657 A1
(43) Pub. Date: Aug. 6, 2009

(54) Developing Device, Image Forming Apparatus, and Image Forming Method

(75) Inventors: Naoyuki OKUMURA, Nagano-ken (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/358,019

(22) Filed: Jan. 22, 2009

(30) Foreign Application Priority Data
Feb. 6, 2008 (JP) 2008-026458
Oct. 15, 2008 (JP) 2008-265947

(51) Int. Cl. G03G 15/10

(52) U.S. Cl. 399/237; 399/249; 399/238

(57) ABSTRACT

A developing device includes: a developer carrier which carries liquid developer containing toner and carrier liquid; a developer carrier contact member which contacts the developer carrier; and a developer carrier contact control unit which controls the condition where the developer carrier and the developer carrier contact member contact each other with first contact pressure and the condition where the developer carrier and the developer carrier contact member contact each other with second contact pressure lower than the first contact pressure.

### BACKGROUND

1. Technical Field

The present invention relates to a developing device, an image forming apparatus, and an image forming method, which use liquid developer containing toner dispersed in carrier liquid.

2. Related Art

A structure which uses a rubber developing roller as a developer carrier for carrying liquid developer is known. According to this structure, pressure is constantly applied to the nip portion between the developing roller and a photosensitive body. When this pressure is kept applied for a long time, distortion (deformation) of the developing roller is produced. In this case, the toner film thickness varies at the deformed portion, and concentration unevenness is produced on images. For overcoming this problem, JP-A-2001-324877 proposes a technology for removing pressure applied to a developing roller, an application roller, a blade, or the like.

According to the technology disclosed in JP-A-2001-324877, the developing roller, the application roller, the blade, or the like are completely separated. When the developing roller is separated away from the photosensitive body, developer remaining at the nip portion flows along the photosensitive body downward in the gravity direction. The drop of developer pollutes an electrifier, an exposing device, or the like, and lowers electrifying performance, exposing performance, or other characteristics in some cases.

### SUMMARY

It is an advantage of some aspects of the invention to provide a developing device, an image forming apparatus, and an image forming method capable of reducing drop of liquid developer flowing along a latent image carrier and falling onto an electrifier or an exposing device disposed in the gravity direction, and maintaining electrifying performance and exposing performance. It is another advantage of some aspects of the invention to provide a developing device, an image forming apparatus, and an image forming method capable of reducing deformation of a component contacting a latent image carrier.

A developing device according to a first aspect of the invention includes: a developer carrier which carries liquid developer containing toner and carrier liquid; a developer carrier contact member which contacts the liquid developer carrier; and a developer carrier contact control unit which controls a condition where the developer carrier and the developer carrier contact member contact each other with first contact pressure and a condition where the developer carrier and the developer carrier contact member contact each other with second contact pressure lower than the first contact pressure.

It is preferable that the developer carrier contact control unit separates the developer carrier contact member from the developer carrier in the developing device of the first aspect of the invention.

It is preferable that the developer carrier contact member is a developer carrier cleaning blade which cleans the developer carrier in the developing device of the first aspect of the invention.

It is preferable that the developer carrier contact member is a developer supply member which supplies the liquid developer to the developer carrier in the developing device of the first aspect of the invention.

An image forming apparatus according to a second aspect of the invention includes: a latent image carrier; an electrifying unit which electrifies the latent image carrier; an exposing unit which exposes the latent image carrier electrified by the electrifying unit; a latent image carrier contact member which contacts the latent image carrier; and a latent image carrier contact control unit which controls a condition where the latent image carrier and the latent image carrier contact member contact each other with first contact pressure and a condition where the latent image carrier and the latent image carrier contact member contact each other with second contact pressure lower than the first contact pressure.

It is preferable that a second latent image carrier contact member disposed below the latent image carrier contact member in the vertical direction is further included in the image forming apparatus according to the second aspect of the invention.

It is preferable that a second latent image carrier contact control unit which controls a condition where the latent image carrier and the second latent image carrier contact member contact each other with third contact pressure and a condition where the latent image carrier and the second latent image carrier contact member contact each other with fourth contact pressure lower than the third contact pressure is further included in the image forming apparatus according to the second aspect of the invention.

It is preferable that the latent image carrier contact member is a squeeze roller which squeezes the latent image carrier, and that the second latent image carrier contact member is a developer carrier which develops the latent image carrier in the image forming apparatus according to the second aspect of the invention.

It is preferable that the latent image carrier contact member is a latent image carrier cleaning roller in the image forming apparatus according to the second aspect of the invention.

It is preferable that the second latent image carrier contact member is a latent image carrier cleaning blade in the image forming apparatus according to the second aspect of the invention.

It is preferable that a latent image carrier contact regulating member which regulates a position of the latent image carrier contact member at a time of contact with the second contact pressure is further included in the image forming apparatus according to the second aspect of the invention.

It is preferable that the latent image carrier contact control unit is a latent image carrier contact member urging spring which urges the latent image carrier contact member toward the latent image carrier in the image forming apparatus according to the second aspect of the invention.

An image forming method according to a third aspect of the invention includes: bringing a latent image carrier and a developer carrier into contact with each other with first contact pressure by a latent image carrier contact member control unit; performing an image formation process for developing a latent image exposed on the latent image carrier by an exposing unit using the developer carrier and transferring the developed image to a transfer material by contact between the latent image carrier and the developer carrier; and bringing the latent image carrier and the developer carrier into contact with each other with second contact pressure lower than the first contact pressure by the latent image carrier contact member control unit after completion of the image formation process.

It is preferable that the latent image carrier and the developer carrier are brought into contact with each other with the second contact pressure after driving of the latent image carrier and the developer carrier stops in the image forming method according to the third aspect of the invention.

It is preferable that a squeeze roller contacting the latent image carrier developed by the developer carrier is provided, and that the latent image carrier is separated from the squeeze roller after driving of the latent image carrier and the developer carrier stops in the image forming method according to the third aspect of the invention.

According to the developing device in the first aspect of the invention, drop of liquid developer along the developer carrier toward the components disposed in the gravity direction can be reduced.

According to the developing device in the first aspect of the invention, permanent distortion of the developer carrier and concentration unevenness of images can be decreased.

According to the image forming apparatus in the second aspect of the invention, drop of liquid developer along the latent image carrier toward the electrifier and the exposing device disposed in the gravity direction can be reduced. Thus, electrification performance and exposure performance can be maintained.

According to the image forming apparatus in the second aspect of the invention, permanent distortion of the latent image carrier contact member and concentration unevenness of images can be decreased.

### BRIEF DESCRIPTION OF THE DRAWINGS

The invention will be described with reference to the accompanying drawings, wherein like numbers reference like elements.

FIG. 1 illustrates an image forming apparatus according to an embodiment.

FIG. 2 is a cross-sectional view showing main constituent elements around a photosensitive body and of a developing unit.

FIG. 3 is a perspective view of a developer supply member.

FIG. 4 illustrates compression of developer by a developer compression device.

FIG. 5 illustrates image development by a developing roller.

FIG. 6 illustrates squeezing operation by a squeeze roller.

FIG. 7 illustrates condition around the photosensitive body and the developing unit during standby.

FIG. 8 illustrates condition around a photosensitive body and a developing unit in another embodiment.

FIG. 9 is a cross-sectional view showing main constituent elements around the photosensitive body and of the developing unit under first condition.

FIG. 10 illustrates an enlarged nip portion between the developing roller and the photosensitive body under the first condition.

FIG. 11 is a cross-sectional view showing main constituent elements around the photosensitive body and of the developing unit under second condition.

FIG. 12 illustrates an enlarged nip portion between the developing roller unit and the photosensitive body under the second condition.

### DESCRIPTION OF EXEMPLARY EMBODIMENTS

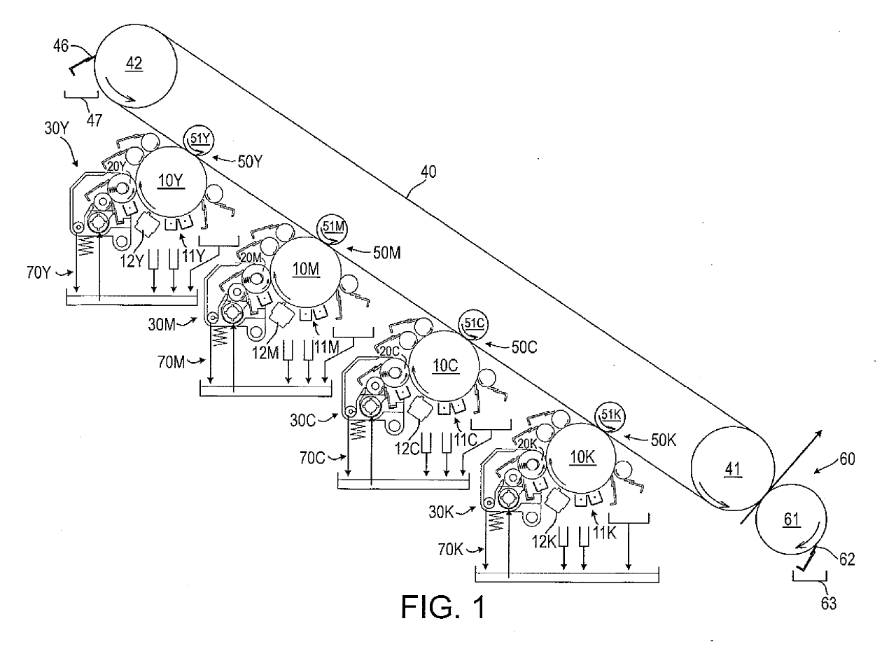

An embodiment according to the invention is hereinafter described with reference to the drawings. FIG. 1 illustrates main components constituting an image forming apparatus according to the embodiment of the invention. Developing units 30Y, 30M, 30C, and 30K as developing devices, and developer collect and supply devices 70Y, 70M, 70C, and 70K are disposed in the lower region of the image forming apparatus relative to latent image carriers 10Y, 10M, 10C, and 10K disposed at the central region of the image forming apparatus. An intermediate transfer belt 40 and a secondary transfer unit 60 as intermediate transfer members are disposed in the upper region of the image forming apparatus.

Electrifiers 11Y, 11M, 11C, and 11K, exposing units 12Y, 12M, 12C, and 12K, and other components are disposed around the photosensitive bodies 10Y, 10M, 10C, and 10K as an example of latent image carriers. The exposing units 12Y, 12M, 12C, and 12K are constituted by line heads containing LED or the like arranged in line or other components. The photosensitive bodies 10Y, 10M, 10C, and 10K are uniformly electrified by the electrifiers 11Y, 11M, 11C, and 11K, and modified laser beams are applied by the exposing units 12Y, 12M, 12C, and 12K according to input image signals to form electrostatic latent images on the electrified photosensitive bodies 10Y, 10M, 10C, and 10K,

The developing units 30Y, 30M, 30C, and 30K chiefly include developing rollers 20Y, 20M, 20C, and 20K as developer carriers, developer containers 31Y, 31M, 31C, and 31K storing liquid developer in colors of yellow (Y), magenta (M), cyan (C), and black (K), developer supply rollers 32Y, 32M, 32C, and 32K for supplying the liquid developer in respective colors as a developer supply member from the developer containers 31Y, 31M, 31C, and 31K to the developing rollers 20Y, 20M, 20C, and 20K, and other components. The developing units 30Y, 30M, 30C and 30K develop electrostatic latent images formed on the photosensitive bodies 10Y, 10M, 10C, and 10K by using the liquid developer in respective colors.

The intermediate transfer belt 40 is an endless belt wound around a drive roller 41 and a tension roller 42 with tension and rotated by the drive roller 41 while contacting the photosensitive bodies 10Y, 10M, 10C, and 10K at the positions of primary transfer units 50Y, 50M, 50C and 50K. At the primary transfer units 50Y, 50M, 50C, and 50K, primary transfer rollers 51Y, 51M, 51C, and 51K are opposed to the photosensitive bodies 10Y, 10M, 10C, and 10K with the intermediate transfer belt 40 sandwiched therebetween. The primary transfer units 50Y, 50M, 50C, and 50K sequentially stack toner images in respective colors formed on the intermediate transfer belt 40 and transfer the stacked toner images to the intermediate transfer belt 40 to form full-color toner images.

At the secondary transfer unit 60, a secondary transfer roller 61 is opposed to the belt drive roller 41 with the intermediate transfer belt 40 sandwiched therebetween. A cleaning device having a secondary transfer roller cleaning blade 62 and a developer collecting unit 63 is further disposed at the secondary transfer unit 60. The secondary transfer unit 60 feeds and supplies sheet material such as sheet, film, and fabric through a sheet material feed path (not shown) at the timing that full-color toner images or monochrome toner images stacked in colors on the intermediate transfer belt 40 reach the transfer position of the second transfer unit 60, and secondarily transfers the monochrome toner images or full-color toner images to the sheet material. A not-shown fixing unit is disposed in front of the sheet material feed path to fuse and fix the monochrome toner images or full-color toner images transferred on the sheet material to a recording medium (sheet material) such as sheet to complete final image forming process on the sheet material.

A cleaning device having an intermediate transfer belt cleaning blade 46 and a developer collecting unit 47 is disposed along the outer circumference of the tension roller 42, and the intermediate transfer belt 40 is wound around the tension roller 42 and the belt drive roller 41 with tension. The intermediate transfer belt 40 after passing the secondary transfer unit 60 proceeds to the position of the tension roller 42 around which the intermediate transfer belt 40 is wound, where the intermediate transfer belt 40 is cleaned by the intermediate transfer belt cleaning blade 46 and again returns to the primary transfer unit 50.

The developer collect and supply devices 70Y, 70M, 70C, and 70K control concentration of liquid developer collected from the photosensitive bodies 10Y, 10M, 10C, and 10K, and the developing units 30Y, 30M, 30C, and 30K, and supplies the liquid developer to the developer containers 31Y, 31M, 31C, and 31K.

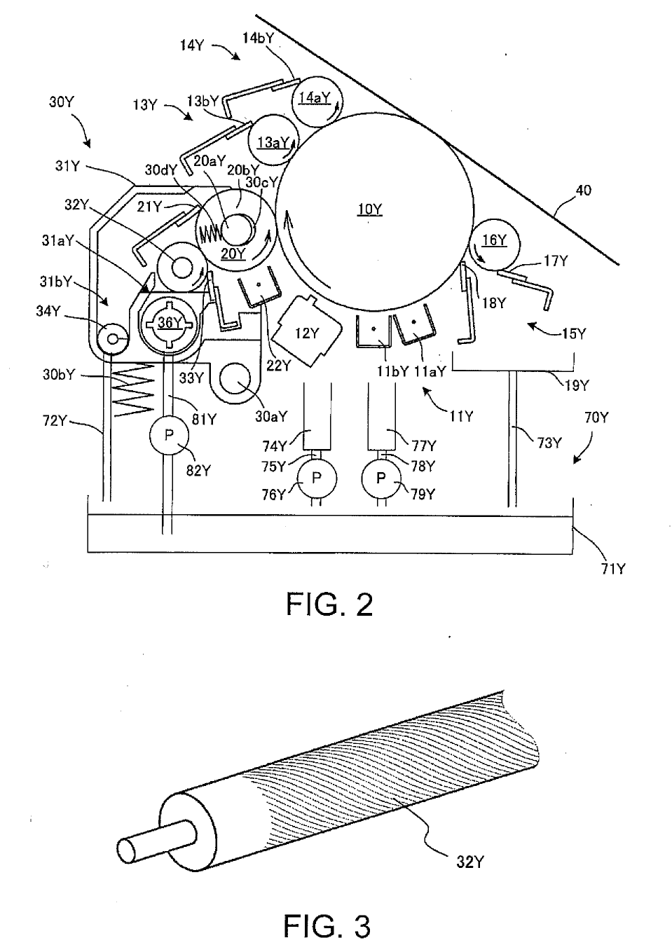

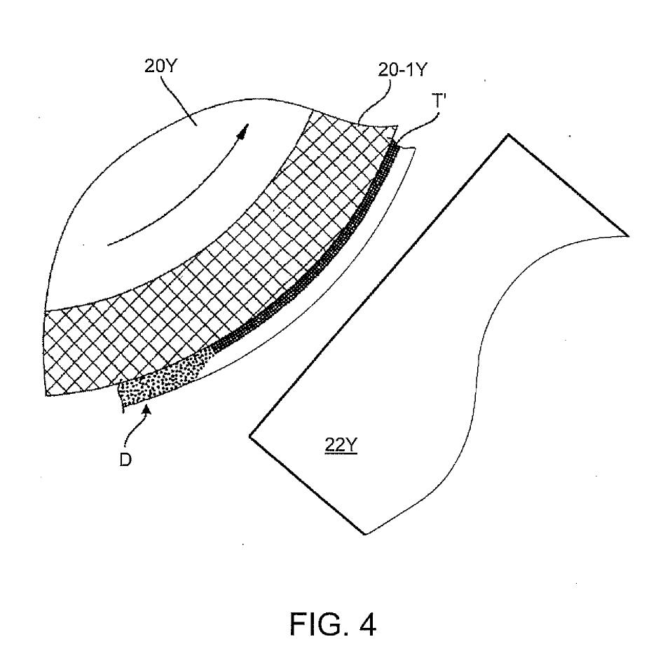

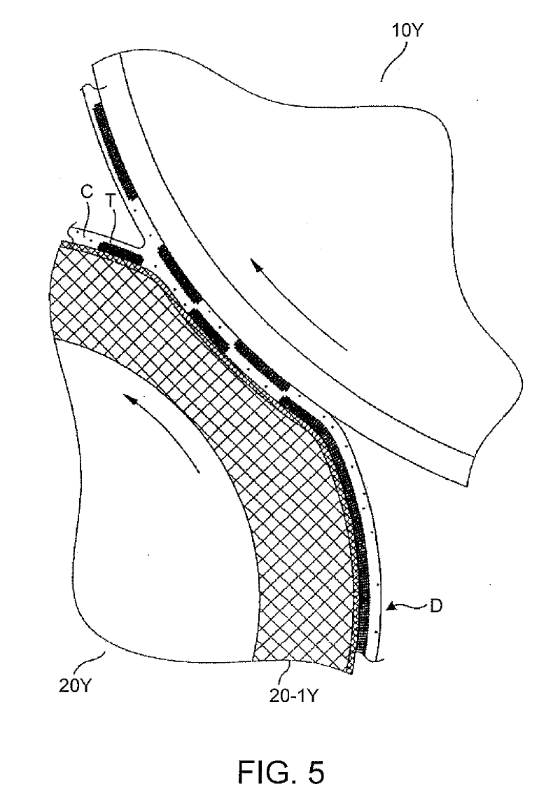

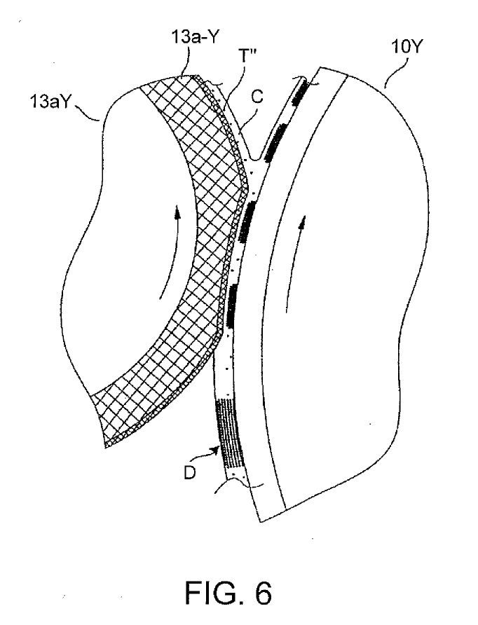

The photosensitive bodies 10Y, 10M, 10C, and 10K and the developing units 30Y, 30M, 30C, and 30K as an example of the developing device are now described. FIG. 2 is a cross-sectional view showing the main constituent elements around the photosensitive body 10Y and of the developing unit 30Y. FIG. 3 illustrates a developer supply member. FIG. 4 illustrates compression of developer by a developer compression device 22Y. FIG. 5 illustrates image development by the developing roller 20Y. FIG. 6 illustrates squeezing operation by a squeeze roller 13Y. The photosensitive bodies 10Y, 10M, 10C, and 10K, and the developing units 30Y, 30M, 30C, and 30K have similar structures for each color, and thus only the surroundings of the yellow (Y) photosensitive body 10Y and the developing unit 30Y are discussed herein.

A photosensitive body cleaning unit 15Y as an example of latent image carrier cleaning unit, the electrifier 11Y, the exposing unit 12Y, a developing roller 20Y of the developing unit 30Y, a first squeeze device 13Y having a first squeeze roller 13aY and a first squeeze roller cleaning blade 13bY, and a second squeeze device 14Y having a second squeeze roller 14aY and a second squeeze roller cleaning blade 14bY are disposed around the photosensitive body 10Y in the rotation direction of the outer circumference of the photosensitive body 10Y. A developing roller cleaning blade 21Y as a developer carrier cleaning blade, and a developer supply roller 32Y using an anilox roller are disposed on the outer circumference of the developing roller 20Y of the developing unit 30Y. A liquid developer stirring paddle 36Y as a stirring member, and a developer supply roller 32Y are accommodated in the liquid developer container 31Y. The primary transfer roller 51Y of the primary transfer unit is provided at the position opposed to the photosensitive body 10Y along the intermediate transfer belt 40.

The photosensitive body 10Y is a photosensitive drum constituted by a cylindrical component having width larger than the width of the developing roller 20Y of about 320 mm and having a photosensitive layer on the outer circumference. The photosensitive body 10Y rotates clockwise as shown in FIG. 2, for example. The photosensitive layer of the photosensitive body 10Y is constituted by organic photosensitive body, amorphous silicon photosensitive body, or the like.

The photosensitive body cleaning unit 15Y has a photosensitive body cleaning roller 16Y as an example of a cylindrical latent image carrier cleaning roller having diameter of about 20 mm, a photosensitive body cleaning roller blade 17Y as an example of a latent image carrier cleaning roller blade disposed on the outer circumference of the photosensitive body cleaning roller 16Y to scrape developer on the photosensitive body cleaning roller 16Y, a photosensitive body cleaning blade 18Y as an example of a latent image carrier cleaning blade contacting the photosensitive body 10Y to scrape developer on the photosensitive body 10Y, and a photosensitive body developer collecting unit 19Y as an example of latent image carrier developer collecting unit for collecting developer scraped by the photosensitive body cleaning roller blade 17Y and the photosensitive body cleaning blade 18Y.

The photosensitive body cleaning roller 16Y contacts with and separates from the photosensitive body 10Y. The photosensitive body cleaning roller 16 may be so structured as to shift with the photosensitive body cleaning roller blade 17Y as one body. The photosensitive body cleaning blade 1BY contacts with and separates from the photosensitive body 10Y.

The electrifier 11Y is disposed upstream from the nip portion between the photosensitive body 10Y and the developing roller 20Y in the rotation direction of the photosensitive body 10Y, and positioned substantially in the gravity direction of the photosensitive body 10Y. The electrifier 11Y receives bias having the same polarity as the electrification polarity of developing toner particles from a not-shown power supply device to electrify the photosensitive body 10Y. The electrifier 11 has a pair of first electrifier 11a and second electrifier 11b to provide fine setting of the electrifying voltage by turning on both, turning on either of the two, turning off both, or reducing outputs from both to half.

The exposing unit 12Y is disposed downstream in the rotation direction of the photosensitive body 10Y from the electrifier 11Y disposed substantially in the gravity direction. More specifically, the exposing unit 12Y is disposed in the gravity direction of the photosensitive body 10Y on the developing roller 20Y side (left side in the figure) with respect to the vertical line passing the rotation center of the photosensitive body 10Y. The exposing unit 12Y exposes the photosensitive body 10Y electrified by the electrifier 11Y to form latent images on the photosensitive body 10Y.

The developing unit 30Y has the developing roller 20Y carrying the liquid developer, the developing roller cleaning blade 21Y cleaning the developing roller 20Y, the developer compression member 22Y forming compressed condition of developer on the developing roller 20Y, the developer supply roller 32Y and a developer regulating blade 33Y stirring liquid developer to maintain uniformly dispersed condition of the liquid developer and supply the liquid developer to the developing roller 20Y, the developer container 31Y storing liquid developer which contains approximately 25% by weight of toner disposed in carrier liquid, and other components. The developer container 31Y has a supply unit 31aY and a collect unit 31bY. The supply unit 31aY has the stirring paddle 36Y for stirring developer in the developer container 31Y and other parts. The collect unit 31bY has a collect screw 34Y for collecting liquid developer scraped by the developing roller cleaning blade 21Y, the first squeeze roller cleaning blade 13bY, and the second squeeze cleaning blade 14bY and feeding the collected developer to a liquid developer storage unit 71Y, and other parts.

The liquid developer stored in the developer container 31Y is not volatile liquid developer generally used in related art which contains Isopar (trademark: Exxon) as carrier liquid and has low concentration (about 1-2 wt %) , low viscosity, and volatility at room temperature, but non-volatile liquid developer having high concentration, high viscosity, and non-volatility at room temperature. More specifically, the liquid developer according to this embodiment is liquid developer having high viscosity (about 30 to 10,000 mPa·s) and toner solid concentration of about 25%, which is produced by adding solid bodies having average particle diameter of 1 μm and containing colorant such as pigment dispersed in thermoplastic resin to liquid solvent such as organic solvent, silicon oil, mineral oil, and edible oil with dispersant.

The developer supply roller 32Y is a cylindrical anilox roller which has fine and uniform concave and convex surface produced by spiral grooves so as to carry developer on the surface as illustrated in FIG. 3. The developer supply roller 32Y rotates anticlockwise as illustrated in FIG. 2. The grooves have the groove pitch of about 130 μm and the groove depth of about 30 μm. Liquid developer is supplied from the developer container 31Y to the developing roller 20Y by the developer supply roller 32Y. The stirring paddle 36Y and the developer supply roller 32Y may slidingly contact each other, or may be disposed away from each other.

The developer regulating blade 33Y has a rubber unit constituted by parts such as a metal blade, an elastic blade formed by covering elastic body on the surface, and urethane rubber contacting the surface of the developer supply roller 32Y, and a plate such as a metal plate supporting the rubber unit. The developer regulating blade 33Y regulates and adjusts the film thickness and amount of the liquid developer carried and fed by the developer supply roller 32Y having an anilox roller to control the amount of liquid developer to be supplied to the developer roller 20Y. The rotation direction of the developer supply roller 32Y is not limited to an arrow direction shown in FIG. 2 but may be the opposite direction. In this case, the developer regulating blade 33Y requires arrangement corresponding to the rotation direction.

The developing roller 20Y is a cylindrical member having width of about 320 mm, which rotates anticlockwise around the rotation axis as illustrated in FIG. 2. The developing roller 20Y has an elastic layer constituted by polyurethane rubber, silicon rubber, NBR or the like on the outer circumference of an inner core made of iron or other metal. The developing roller cleaning blade 21Y is constituted by rubber or the like contacting the surface of the developing roller 20Y, and is positioned downstream in the rotation direction of the developing roller 20Y from the developing nip portion where the developing roller 20Y contacts the photosensitive body 10Y to scrape and remove liquid developer remaining on the developing roller 20Y.

The developer compression device 22Y uses corona discharge from a corona discharger. Toner T uniformly dispersed in carrier liquid C is shifted toward the developing roller 20Y and coagulated by the developer compression device 22Y as illustrated in FIG. 4 to form so-called developer compressed condition T′.

Compressed developer D carried by the developing roller 20Y is developed in correspondence to the latent image on the photosensitive body 10Y by application of desired electric field at the developing nip portion where the developing roller 20Y contacts the photosensitive body 10Y as illustrated in FIG. 5. Then, the developer D remaining after development is scraped and removed by the developing roller cleaning blade 21Y, and collected toward the developer collect screw 34Y accommodated in the developer container 31Y. The carrier liquid and toner to be combined are not in color mixture condition.

The squeeze device as a carrier liquid removing device is now described. The squeeze device according to this embodiment has the first squeeze device 13 and the second squeeze device 14, and is disposed at a position opposed to the photosensitive body 10Y downstream from the developing roller 20Y to contact the photosensitive body 10Y and collect surplus developer of a developed toner image.

The first squeeze device 13 has the first squeeze roller 13aY which has an elastic roller member coated with a first elastic body 13a-1Y on the surface and rotating while slidingly contacting the photosensitive body 10Y as illustrated in FIG. 6, and a first squeeze roller cleaning blade 13bY which cleans the surface of the first squeeze roller 13aY while slidingly contacting the first squeeze roller 13aY with pressure as illustrated in FIG. 2.

Similarly to the first squeeze device 13 shown in FIG. 6, the second squeeze device 14 has the second squeeze roller 14aY which has an elastic roller member coated with a second elastic body 14a-1Y on the surface and rotating while slidingly contacting the photosensitive body 10Y as illustrated in FIG. 6, and a second squeeze roller cleaning blade 14bY which cleans the surface of the second squeeze roller 14aY while slidingly contacting the first squeeze roller 14aY with pressure as illustrated in FIG. 2.

The squeeze devices 13 and 14 have a function of collecting surplus carrier liquid C and unnecessary fogging toner T″ from the developer D developed on the photosensitive body 10Y, and raising toner particle proportion in the visual image. The capability for collecting surplus carrier liquid C can be adjusted to desired collecting capability by controlling the rotation directions of the first squeeze roller 13aY and the second squeeze roller 14aY and relative circumferential speed difference between the surface of the photosensitive body 10Y and the surfaces of the first squeeze roller 13aY and the second squeeze roller 14aY. The collecting capability increases when the first and second squeeze rollers 13aY and 14aY rotate in the counter direction with respect to the photosensitive body 10Y. The collecting capability also increases when the circumferential speed difference is set at a large value. Synergism of these factors is possible.

The surplus carrier liquid C and unnecessary fogging toner T″ collected by the first squeeze roller 13aY and the second squeeze roller 14aY are collected from the first squeeze roller 13aY and the second squeeze roller 14aY toward the developer collect screw 34Y of the developer container 31Y by the functions of the first squeeze roller cleaning blade 13bY and the second squeeze roller cleaning blade 14bY. The collected surplus carrier liquid C and fogging toner T″ are collected from the dedicated and separated photosensitive 10Y. Thus, no color mixture phenomenon is caused in any areas.

The primary transfer unit 50Y transfers the developer image developed on the photosensitive body 10Y to the intermediate transfer belt 40 by using the primary transfer roller 51Y. The photosensitive body 10Y and the intermediate transfer belt 40 are so structured as to shift at equal speed, which reduces drive load for rotation and shift and prevents the photosensitive body 10Y from causing disturbance to the visual toner image.

The developer collect and supply device 70Y has the liquid developer storage unit 71Y which stores collected liquid developer and supplies high-concentration developer from a developer tank 74Y and carrier liquid from a carrier liquid tank 77Y to control concentration.

According to this embodiment, liquid developer is collected from the developing unit 30Y and the photosensitive body 10Y. Liquid developer collected toward the developer collect screw 34Y of the developing unit 30Y is collected by the liquid developer storage unit 71Y through a developing unit collect path 72Y. Liquid developer collected from the photosensitive body 10Y to the photosensitive body developer collecting unit 19Y is collected by the liquid developer storage unit 71Y through a photosensitive body collect path 73Y.

High-concentration developer is supplied from the developer tank 74Y to the liquid developer storage unit 71Y via a developer supply path 75Y and a developer pump 76Y. Carrier liquid is supplied from the carrier liquid tank 77Y to the liquid developer storage unit 71Y via a carrier liquid supply path 78Y and a carrier liquid pump 79Y. The high-concentration developer and carrier liquid may be supplied by opening and closing a valve using gravity instead of a pump or the like.

The liquid developer stored in the liquid developer storage unit 71Y is supplied to the developer container 31Y via a developer supply path 81Y and a developer supply pump 82Y.

Operation of the image forming apparatus according to this embodiment is now described. In this description, the surroundings of the yellow photosensitive body 10Y of the surroundings of the four photosensitive bodies 10Y, 10M, 10C, and 10K and the developing unit 30Y of the developing units 30Y, 30M, 30C, and 30K are discussed as an example.

Toner particles in liquid developer contained in the developer container 31Y have plus charges. The liquid developer is stirred by the stirring paddle 36Y and drawn up from the developer container 31Y by rotation of the developer supply roller 32Y.

The developer regulating blade 33Y contacts the surface of the developer supply roller 32Y and regulates the liquid developer amount to be supplied to the developer roller 20Y by scraping surplus liquid developer while leaving liquid developer in the grooves of the concaves and convexes of anilox patterns formed on the surface of the developer supply roller 32Y. By this regulation, the liquid developer amount is quantized such that the film thickness of the liquid developer applied to the developing roller 20Y becomes about 6 μm. The liquid developer scraped by the developer regulating blade 33Y falls and returns into the developer container 31Y by gravity. The liquid developer not scraped by the regulating blade 33Y is accommodated within the grooves of the concaves and convexes on the surface of the developer supply roller 32Y, and applied to the surface of the developing roller 20Y by contacting the developing roller 20Y with pressure.

The developing roller 20Y to which the liquid developer has been applied by the developer supply roller 32Y contacts the developer compression device 22Y at a position downstream from the nip portion between the developing roller 20Y and the developer supply roller 32Y. Bias of about +400 V is applied to the developing roller 20Y, and bias higher than that of the developing roller 20Y and having the same polarity as the electrification polarity of toner is applied to the developer compression device 22Y. For example, bias of about +4 kV is applied to the developer compression device 22Y.

The photosensitive body 10Y is made of amorphous silicon. After the surface of the photosensitive body 10Y is electrified to have about +600 V by the electrifier 11Y at a position upstream from the nip portion between the developing roller 20Y and the photosensitive body 10Y, a latent image is formed by the exposing unit 12Y such that the voltage of the image portion becomes +25 V. At the developing nip portion formed between the developing roller 20Y and the photosensitive body 10Y, the toner particles T are selectively shifted to the image portion on the photosensitive body 10Y according to the electric field produced by bias +400 V applied to the developing roller 20Y and the latent image (image portion: +25 V, non image portion: +600 V) on the photosensitive body 10Y as illustrated in FIG. 5. As a result, a toner image is formed on the photosensitive body 10Y. The carrier liquid C which does not receive the effect of the electric field is separated at the exit of the developing nip portion between the developing roller 20Y and the photosensitive body 10Y as illustrated in FIG. 5, and adheres to both the developing roller 20Y and the photosensitive body 10Y.

The photosensitive body 10Y having passed through the developing nip portion passes the squeeze roller 13Y. The squeeze roller 13Y has a function of collecting the surplus carrier liquid C and the unnecessary fogging toner T″ from the developer D developed on the photosensitive body 10Y as illustrated in FIG. 6, and raising the toner particle proportion in the visual image. The capability for collecting surplus carrier liquid C can be adjusted to desired collecting capability by controlling the rotation directions of the first squeeze roller 13aY and the second squeeze roller 14aY and relative circumferential speed difference between the surface of the photosensitive body 10Y and the surfaces of the first squeeze roller 13aY and the second squeeze roller 14aY. The collecting capability increases when the first and second squeeze rollers 13aY and 14aY rotate in the counter direction with respect to the photosensitive body 10Y. The collecting capability also increases when the circumferential speed difference is large. Synergism of these factors is possible.

According to this embodiment, the first squeeze roller 13aY and the second squeeze roller 14aY are with-rotated at substantially the same circumferential speed with respect to the photosensitive body 10Y as illustrated in FIG. 6, for example. By this method, 5-10 weight % of the surplus carrier liquid C is collected from the developer D developed on the photosensitive body 10Y to reduce rotation drive load of both the first and second squeeze rollers 13aY and 14aY and prevent the photosensitive body 10Y from causing disturbance to the visual toner image.

Then, the photosensitive body 10Y passes the nip portion between the photosensitive body 10Y and the intermediate transfer belt 40 at the primary transfer unit 50Y to perform primary transfer of the visual toner image to the intermediate transfer belt 40. Voltage of about −200 V having the opposite polarity of the electrification characteristics of the toner particles is applied to the primary transfer roller 51Y. As a result, toner is primarily transferred from the photosensitive body 10Y to the intermediate transfer belt 40, and only the carrier liquid remains on the photosensitive body 10Y. The photosensitive body 10Y after primary transfer is cleaned by the photosensitive body cleaning roller 16Y at a position downstream from the primary transfer unit in the rotation direction of the photosensitive body 10Y. The carrier liquid remaining on the photosensitive body 10Y is scraped by the photosensitive body cleaning blade 18Y and collected by the developer collecting unit 19Y.

The toner image formed by primarily transferring the toner images formed on the plural photosensitive bodies 10 and sequentially stacking and carrying the toner images on the intermediate transfer belt 40 proceeds to the secondary transfer unit 60 to enter the nip portion between the intermediate transfer belt 40 and the secondary transfer roller 61. The nip width in this step is set at 3 mm. At the secondary transfer unit 60, voltage of −1200 V is applied to the secondary transfer roller 61, and voltage of +200 V is applied to the belt drive roller 41. By these voltages, the toner image on the intermediate transfer belt 40 is transferred to a recording medium such as sheet (sheet material).

When sheet material supply trouble such as jams is caused, however, not all the toner images are transferred to the secondary transfer roll and not collected thereby but a part of the toner images remains on the intermediate transfer belt. Even in the ordinary secondary transfer process, not 100% of the toner images on the intermediate transfer belt are secondarily transferred and not shifted to the sheet material, but several percent of the toner images remain after the secondary transfer. Particularly when sheet material supply trouble such as jams is caused, the toner images contact the secondary transfer roller 61 and are transferred without presence of the sheet material. As a result, the back surface of the sheet material becomes dirty.

According to this embodiment, the carrier liquid is collected (squeezed) toward the secondary transfer roller 61, and the intermediate transfer belt 40 is cleaned by the intermediate transfer belt cleaning blade 46 and the developer collecting unit 47 with respect to these unnecessary toner images. Also, the secondary transfer roller 61 is cleaned by the secondary transfer roller cleaning blade 62.

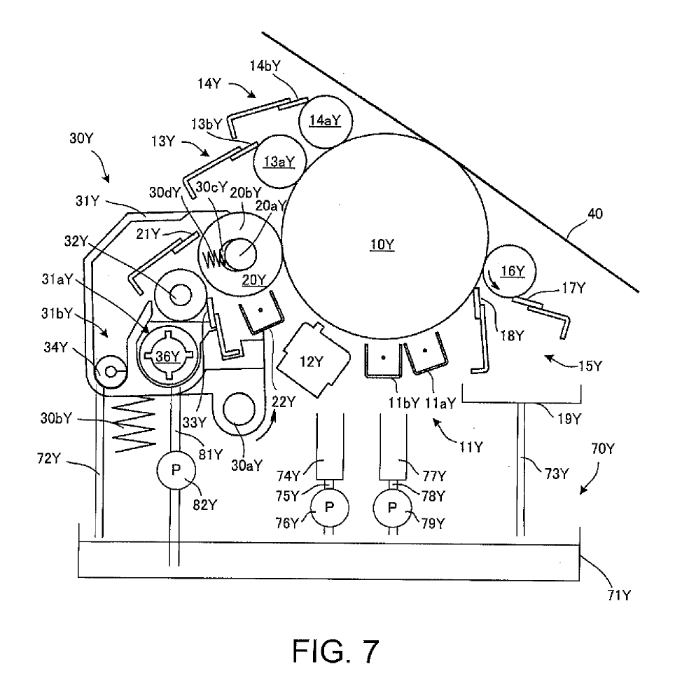

A contact pressure control mechanism according to this embodiment is now described. FIG. 7 shows the condition around the photosensitive body 10Y during standby such as a non image forming period.

As illustrated in FIG. 2, the developing unit 30Y in this embodiment contacts the photosensitive body 10Y during the non image forming period or the like for preventing permanent distortion of the developing roller 20Y or the like. In this structure, the developing unit 30Y can be shifted around a swing support 30aY toward a position receiving weak contact pressure from the developing roller 20Y. The swing support 30aY is a shaft-shaped member such as a pin provided below the developer container 31Y on the photosensitive body 10Y side, and is rotated by driving force from a not-shown motor or the like. A swing spring 30bY as a control unit is provided below the developer container 31Y of the developing unit 30Y on the side opposite to the photosensitive body 10Y. The swing spring 30bY urges the developing unit 30Y in the direction for pressing the developing roller 20Y toward the photosensitive body 10Y around the swing support 30aY such that the contact pressure of the developing roller 20Y to the photosensitive body 10Y can be controlled by the urging force.

The developing unit 30Y further has an elongate hole 30cY through which a shaft 20aY of a roller 20bY penetrates, and a shaft urging spring 30dY as a shaft urging unit for urging the shaft 20aY in the direction of contact between the roller 20bY and the photosensitive body 10Y. The shaft urging spring 30dY has weaker force than the force of the swing spring 30bY.

The developing roller 20Y has the shaft 20aY as the rotation center, and the roller 20bY surrounding the shaft 20aY.

As illustrated in FIG. 2, the developing unit 30Y is urged around the swing support 30aY by the urging force of the swing spring 30bY so as to form a nip portion by the contact between the photosensitive body 10Y and the developing roller 20Y at the time of image formation or the like. In this case, the contact pressure of the shaft urging force 30dY is small and gives no effect on the developing roller 20Y.

In the standby condition such as a non image forming period, the urging force of the swing spring 30bY is weakened as illustrated in FIG. 7. As a result, the developing unit 30Y swings anticlockwise in the figure around the swing support 30aY, and the developing roller 20Y swings accordingly. In this case, the shaft 20aY is pressed by the shaft urging spring 30dY and shifted in the elongate hole 30cY, and the roller 20bY remains while contacting the photosensitive body 10Y. However, the contact pressure of the developing roller 20Y to the photosensitive body 10Y during this period becomes weaker than that at the time of image forming. The photosensitive body cleaning roller 16Y and the photosensitive body cleaning blade 18Y may be kept contact with each other.

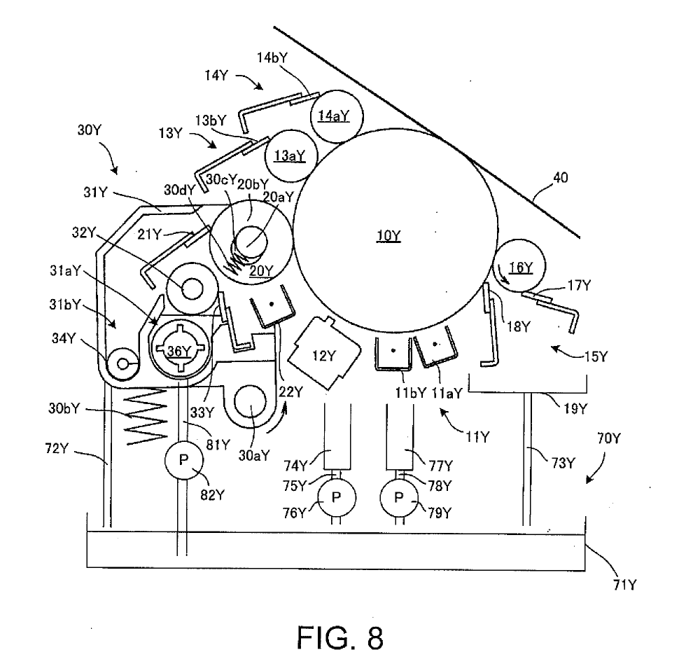

According to this embodiment, the developer supply roller 32Y and the developing roller cleaning blade 21Y are positioned away from each other. However, the developing roller cleaning blade 21Y may contact the developer supply roller 32Y with smaller contact pressure than that at the time of image forming according to another embodiment as illustrated in FIG. 8.

As described above, the image forming apparatus according to this embodiment includes the photosensitive body 10Y, the electrifier 11Y for uniformly electrifying the photosensitive body 10Y, the exposing unit 12Y for exposing the photosensitive body 10Y electrified by the electrifier 11Y and forming an electrostatic latent image, the developing roller 20Y for applying liquid developer containing developer solid component and non-volatile liquid carrier on the photosensitive body 10Y by using the contact unit having elasticity to develop the electrostatic latent image formed on the photosensitive body 10Y, and the control unit 30bY for controlling the contact pressure between the photosensitive body 10Y and the developer roller 20Y. Since the control unit 30bY is disposed on the developing unit 30Y supporting the developer roller 20Y, drop of liquid developer along the photosensitive body 10Y toward the electrifier 11Y and the exposing unit 12Y disposed in the gravity direction is reduced. Thus, the electrification performance and exposure performance are maintained, and permanent distortion of the developing roller 20Y is reduced. Accordingly, concentration unevenness of images is decreased.

The control unit 30bY reduces the contact pressure while maintaining the contact between the photosensitive body 10Y and the developing roller 20Y during the non image forming period. Thus, the photosensitive body 10Y and the developing roller 20Y are not positioned away from each other, and drop of liquid developer along the photosensitive body 10Y toward the electrifier 11Y and the exposing unit 12Y disposed in the gravity direction is reduced. Accordingly, the electrification performance and exposure performance are maintained.

According to this embodiment, the photosensitive body cleaning unit 15Y for cleaning the photosensitive body 10Y is in contact with the photosensitive body 10Y during the non image forming period. Since the photosensitive body 10Y and the photosensitive body cleaning 15Y are not positioned away from each other, drop of liquid developer along the photosensitive body 10Y toward the electrifier 11Y and the exposing unit 12Y disposed in the gravity direction is reduced. Accordingly, the electrification performance and exposure performance are maintained.

The developing roller contact members 21Y and 32Y contacting the developing roller 20Y at the time of image formation reduce the contact pressure while contacting the developing roller 20Y during non image forming period. Thus, the permanent distortion of the developing roller 20Y and concentration unevenness of images decrease.

The developing roller contact members 21Y and 32Y contacting the developing roller 20Y at the time of image formation are positioned away from the developing roller 20Y during the non image forming period. Thus, the permanent distortion of the developing roller 20Y and concentration unevenness of images decrease.

The developing roller contact members 21Y and 32Y contain at least the developing roller cleaning member 21Y for cleaning the developing roller 20Y or the developer supply member 32Y for supplying liquid developer to the developing roller 20Y. Thus, the permanent distortion of the developing roller 20Y and concentration unevenness of images decrease.

The control unit 30bY has the swing spring 30bY for swinging the developing unit 30Y. Thus, cost reduction can be achieved by simplifying the structure.

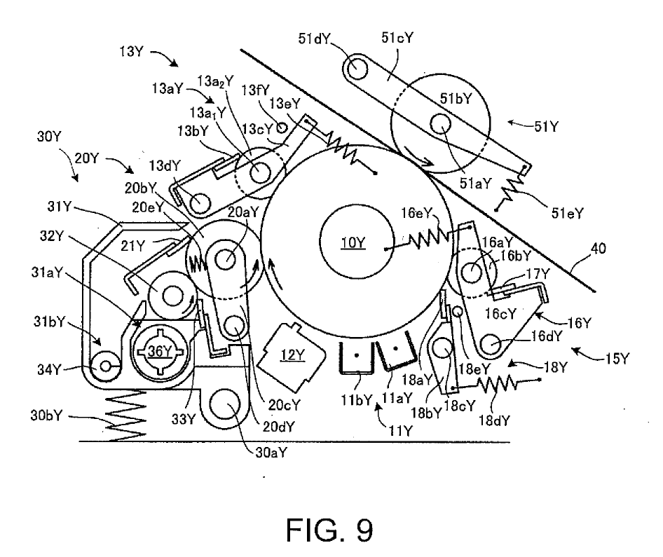

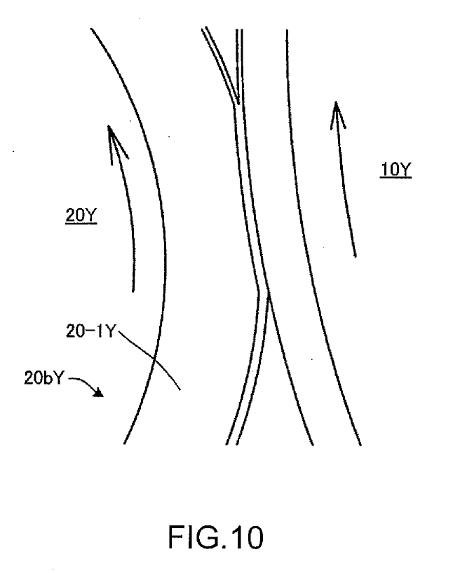

The photosensitive bodies 10Y, 10M, 10C, and 10K and the developing units according to another embodiment are now described. FIG. 9 is a cross-sectional view showing main structure elements around the photosensitive body 10Y and of the developing unit 30Y. Since the photosensitive bodies 10Y, 10M, 10C, and 10K and the developing units 30Y, 30M, 30C, and 30K have similar structures for each color, only the surroundings of the photosensitive body 10Y and the developing unit 30Y for yellow (Y) are discussed herein.

The photosensitive body cleaning unit 15Y as an example of a latent image carrier cleaning unit, the electrifier 11Y as an electrifying unit, the exposing unit 12Y as an exposing unit, the developing roller 20Y of the developing unit 30Y as a developer carrier, and the squeeze device 13Y as a squeeze unit constituted by the squeeze roller 13aY and the squeeze roller cleaning blade 13bY are disposed around the photosensitive body 10Y as a latent image carrier in the rotation direction of the outer circumference of the photosensitive body 10Y. The developing unit 30Y has the developing roller cleaning blade 21Y as a developer carrier contact member, and the developer supply roller 32Y having an anilox roller on the outer circumference of the developing roller 20Y. The liquid developer container 31Y accommodates the liquid developer stirring paddle 36Y as a stirring member and the developer supply roller 32Y. The primary transfer roller 51Y is disposed at a position opposed to the photosensitive body 10Y along the intermediate transfer belt 40.

According to this embodiment, each of the developing roller 20Y, the first squeeze roller 13aY, the primary transfer roller 51Y, the photosensitive body cleaning roller 16Y, and the photosensitive body cleaning blade 18Y as latent image carrier contact members is supported by a lever. In this structure, a first condition giving large pressure to the photosensitive body 10Y and a second condition giving reduced pressure to the photosensitive body 10Y are provided by rotating the levers.

The developing roller 20Y has the developing roller shaft 20aY, the developing roller section 20bY around the developing roller shaft 20aY, a developing roller lever 20cY as a developer carrier lever for supporting the developing roller shaft 20aY, a developing roller lever shaft 20dY as a developer carrier lever shaft for supporting the developing roller lever 20cY such that the developing roller lever 20cY can rotate, and a developing roller urging spring 20eY for urging the developing roller shaft 20aY, the developing roller section 20bY, and the developing roller lever 20cY such that these components 20aY, 20bY, and 20cY can rotate around the developing roller lever shaft 20dY.

The first squeeze device 13Y includes the first squeeze roller 13aY having a first squeeze roller shaft 13a₁Y and a first squeeze roller section 13a₂Y around the first squeeze roller shaft 13a₁Y, the first squeeze roller cleaning blade 13bY for scraping liquid developer on the first squeeze roller 13aY, a first squeeze lever 13cY for supporting the first squeeze roller shaft 13a₁Y, a first squeeze lever shaft 13dY for supporting the first squeeze lever 13cY such that the first squeeze lever 13cY can rotate, a first squeeze urging spring 13eY for urging the first squeeze roller 13aY and the first squeeze lever 13cY toward the photosensitive body 10Y around the first squeeze lever shaft 13dY, and a first squeeze lever regulating member 13fY for regulating the rotation of the first squeeze lever 13cY.

The primary transfer roller 51Y has a primary transfer roller shaft 51aY, a primary transfer roller section 51bY around the primary transfer roller shaft 51aY, a primary transfer lever 51cY for supporting the primary transfer roller shaft 51aY, a primary transfer lever shaft 51dY for supporting the primary transfer lever 51cY such that the primary transfer lever 51cY can rotate, and a primary transfer roller urging spring 51eY for urging the primary transfer roller shaft 51aY, the primary transfer roller section 51bY, and the primary transfer lever 51cY such that these components 51aY, 51bY and 51cY can rotate around the primary transfer lever shaft 51dY.

The photosensitive body cleaning roller 16Y has a photosensitive body cleaning roller shaft 16aY, a photosensitive body cleaning roller section 16bY around the photosensitive body cleaning roller shaft 16aY, a photosensitive body cleaning roller lever 16cY for supporting the photosensitive body cleaning roller shaft 16aY, a photosensitive body cleaning roller lever shaft 16dY for supporting the photosensitive body cleaning roller lever 16cY such that the photosensitive body cleaning roller lever 16cY can rotate, and a photosensitive body cleaning roller urging spring 16eY for urging the photosensitive body cleaning roller shaft 16aY, the photosensitive body cleaning roller section 16bY, and the photosensitive body cleaning roller lever 16cY toward the photosensitive body 10Y around the photosensitive body cleaning roller lever shaft 16dY. The photosensitive body cleaning roller blade 17Y for scraping liquid developer on the photosensitive body cleaning roller section 16bY is provided on the photosensitive body cleaning roller lever 16cY.

The photosensitive cleaning blade 18Y has a photosensitive cleaning blade section 18aY, a photosensitive body cleaning blade lever 18bY for supporting the photosensitive body cleaning blade section 18aY, a photosensitive body cleaning blade lever shaft 18cY for supporting the photosensitive body cleaning blade lever 18bY such that the photosensitive body cleaning blade lever 18bY can rotate, a photosensitive body cleaning blade urging spring 18dY for urging the photosensitive body cleaning blade section 18aY toward the photosensitive body 10Y around the photosensitive body cleaning blade lever shaft 18cY, and a photosensitive body cleaning blade regulating member 18eY for regulating the rotation of the photosensitive body cleaning blade lever 18bY.

FIG. 9 illustrates printing under the first condition, where the developing roller section 20bY of the developing roller 20Y, the first squeeze roller section 13a₂Y of the first squeeze roller 13aY, the primary transfer roller unit 51bY of the primary transfer roller 51Y, the photosensitive body cleaning roller section 16bY of the photosensitive body cleaning roller 16Y, and the photosensitive body cleaning blade section 18aY of the photosensitive body cleaning blade 18Y are urged toward the photosensitive body 10Y.

FIG. 10 illustrates the enlarged nip portion between the developing roller section 20bY of the developing roller 20Y and the photosensitive body 10Y under the first condition. The developing roller section 20bY has a developing roller elastic section 20-1Y on the circumference.

As illustrated in FIG. 9, the developing roller urging spring 20eY urges the developing roller lever 20cY such that the developing roller section 20bY shifts toward the photosensitive body 10Y under printing condition. By the rotation of the developing roller shaft 20aY, the developing roller section 20bY, and the developing roller lever 20cY of the developing roller 20Y around the developing roller lever shaft 20dY, the nip portion between the developing roller section 20bY and the photosensitive body 10Y is produced. As illustrated in FIG. 10, the developing roller elastic section 20-1Y is urged toward the photosensitive body 10Y, pressed against thereto, and thus deformed. It is preferable that the contact pressure between the developing roller 20Y and the photosensitive body 10Y is set in the range from 3 to 20 kgf.

In the first squeeze device 13Y, the first squeeze urging spring 13eY urges the first squeeze lever 13cY such that the first squeeze roller section 13a₂Y shifts toward the photosensitive body 10Y under printing condition. By the rotation of the first squeeze roller 13aY, the first squeeze roller cleaning blade 13bY, and the first squeeze lever 13cY around the first squeeze lever shaft 13dY, the nip portion between the first squeeze roller section 13a₂Y and the photosensitive body 10Y is produced.

In the primary transfer roller 51Y, the primary transfer roller urging spring 51eY urges the primary transfer lever 51cY such that the first primary transfer roller section 51bY shifts toward the photosensitive body 10Y under printing condition. By the rotation of the primary transfer roller shaft 51aY, the primary transfer roller section 51bY, and the primary transfer lever 51cY around the primary transfer lever shaft 51dY, the nip portion between the primary transfer roller section 51bY and the photosensitive body 10Y is produced via the intermediate transfer belt 40.

In the photosensitive body cleaning roller 16Y, the photosensitive body cleaning roller urging spring 16eY urges the photosensitive body cleaning roller lever 16cY such that the photosensitive body cleaning roller section 16bY shifts toward the photosensitive body 10Y under printing condition. By the rotation of the photosensitive body cleaning roller shaft 16aY, the photosensitive body cleaning roller section 16bY, the photosensitive body cleaning roller lever 16cY, and the photosensitive body cleaning roller blade 17Y around the photosensitive body cleaning roller lever shaft 16dY, the nip portion between the photosensitive body cleaning roller section 16bY and the photosensitive body 10Y is produced.

Similarly to the nip portion between the developing roller section 20bY and the photosensitive body 10Y shown in FIG. 10, the elastic section of the first squeeze roller section 13a₂Y, the elastic section of the primary transfer roller section 51bY, and the elastic section of the photosensitive body cleaning roller section 10Y are pressed against the photosensitive body 10Y and deformed at the nip portions between the photosensitive body 10Y and the first squeeze roller section 13a₂Y, the primary transfer roller section 51bY, and the photosensitive body cleaning roller section 16bY under the printing condition.

In the photosensitive body cleaning blade 18Y, the photosensitive body cleaning blade urging spring 18dY urges the photosensitive body cleaning blade lever 18bY such that the photosensitive body cleaning blade section 18aY shifts toward the photosensitive body 10Y under the printing condition. By the rotation of the photosensitive body cleaning blade section 18aY and the photosensitive body cleaning blade lever 18bY around the photosensitive body cleaning blade lever shaft 18cY, the nip portion between the photosensitive body cleaning blade section 18aY and the photosensitive body 10Y is produced. The photosensitive body cleaning blade section 18aY is pressed against the photosensitive body 10Y and deformed under the printing condition.

When the developing roller elastic section 20-1Y, the elastic section of the first squeeze roller section 13a₂Y, the elastic section of the primary transfer roller section 51bY, the elastic section of the photosensitive body cleaning roller section 16bY, and the photosensitive body cleaning blade section 18aY deformed under the printing condition are left deformed under the non printing condition, there is a possibility that the elastic sections thus deformed are plastically deformed.

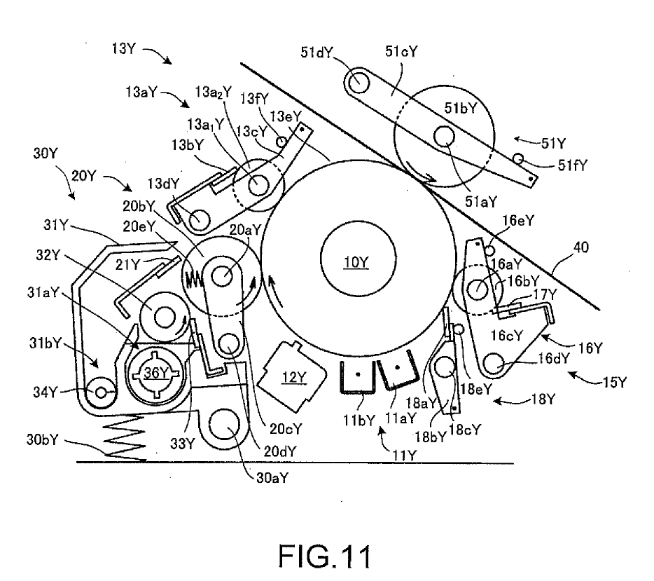

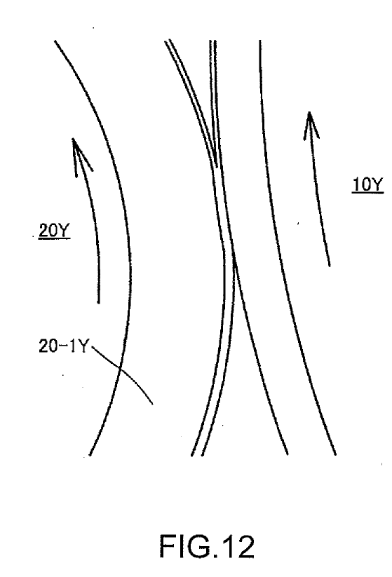

According to this embodiment, therefore, the second condition which reduces pressure of the developing roller elastic section 20-1Y, the elastic section of the first squeeze roller section 13a₂Y, the elastic section of the primary transfer roller section 51bY, the elastic section of the photosensitive body cleaning roller section 16bY, and the photosensitive body cleaning blade 18aY on the photosensitive body 10Y can be provided as illustrated in FIG. 11. FIG. 11 illustrates the second condition.

As illustrated in FIG. 11, the urging force of the swing spring 30bY is weakened during non printing under the second condition. As a result, the developing unit 30Y swings anticlockwise in the figure around the swing support 30aY. At this time, the developing roller 20Y is pressed by the developing roller urging spring 20eY and swings clockwise in the figure around the developing roller lever shaft 20dY. Thus, the developing roller 20Y remains while contacting the photosensitive body 10Y. However, the contact pressure of the developing roller 20Y against the photosensitive body 10Y is decreased and weakened compared with the contact pressure during the image formation. It is preferable that this operation is performed after an image is transferred to the secondary transfer belt and/or after the driving of the photosensitive body 10Y and the developing roller 20Y stops.

FIG. 12 illustrates the enlarged nip portion between the developing roller section 20bY of the developing roller 20Y and the photosensitive body 10Y under the second condition. As illustrated in FIG. 12, the deformation of the developing roller elastic section 20-1Y in the non printing condition is decreased compared with the deformation under the printing condition shown in FIG. 10. It is preferable that the contact pressure between the developing roller 20Y and the photosensitive body 10Y is set in the range from 0.3 to 1 kgf.

The contact pressure of the first squeeze device 13Y, the primary transfer roller 51Y, and the photosensitive body cleaning roller 16Y on the photosensitive body 10Y is similarly decreased under the non printing condition as illustrated in FIG. 11.

The first squeeze device 13Y reduces urging force of the first squeeze urging spring 13eY such that the first squeeze roller section 13a₂Y shifts in the direction away from the photosensitive body 10Y under the non printing condition, and reduces the contact pressure at the nip portion between the first squeeze roller section 13a₂Y and the photosensitive body 10Y by the rotation of the first squeeze roller 13aY, the first squeeze roller cleaning blade 13bY, and the first squeeze lever 13cY around the first squeeze lever shaft 13dY. It is preferable that this operation is performed after the driving of the photosensitive body 10Y and the developing roller 20Y stops.

The primary transfer roller 51Y reduces urging force of the primary transfer roller urging spring 51eY such that the primary transfer roller section 51bY shifts in the direction away from the photosensitive body 10Y under the non printing condition, and reduces the contact pressure at the nip portion between the primary transfer roller section 51bY and the photosensitive body 10Y via the intermediate transfer belt 40 by the rotation of the primary transfer roller shaft 51aY, the primary transfer roller section 51bY, and the primary transfer lever 51cY around the primary transfer lever shaft 51dY and contact of these components 51aY, 51bY, and 51cY with the primary transfer lever regulating member 51fY.

The photosensitive body cleaning roller 16Y reduces urging force of the photosensitive body cleaning roller urging spring 16eY such that the photosensitive body cleaning roller section 16bY shifts in the direction away from the photosensitive body 10Y under the non printing condition, and reduces the contact pressure at the nip portion between the photosensitive body cleaning roller section 16bY and the photosensitive body 10Y by the rotation of the photosensitive body cleaning roller shaft 16aY, the photosensitive body cleaning roller section 16bY, the photosensitive body cleaning roller lever 16cY, and the photosensitive body cleaning roller blade 17Y around the photosensitive body cleaning roller lever shaft 16dY and contact of these components 16aY, 16bY, 16cY, and 17Y with the photosensitive body cleaning roller lever regulating member 16eY.

Similarly to the nip portion between the developing roller section 20bY and the photosensitive body 10Y shown in FIG. 12, the nip portions between the photosensitive body 10Y and the first squeeze roller section 13a₂Y, the primary transfer roller section 51bY, and the photosensitive body cleaning roller section 16bY shift in the direction away from the photosensitive body 10Y under the non printing condition, and deformations of the elastic section of the first squeeze roller section 13a₂Y, the elastic section of the primary transfer roller section 51bY, and the elastic section of the photosensitive body cleaning roller section 16bY are reduced.

The photosensitive body cleaning blade 18Y reduces urging force of the photosensitive body cleaning blade urging spring 18dY such that the photosensitive body cleaning blade section 18aY shifts in the direction away from the photosensitive body 10Y under the non printing condition, and reduces the contact pressure at the nip portion between the photosensitive body cleaning blade section 18aY and the photosensitive body 10Y by the rotation of the photosensitive body cleaning blade section 18aY and the photosensitive body cleaning blade lever 18bY around the photosensitive body cleaning blade lever shaft 18cY. The photosensitive body cleaning blade section 18aY shifts in the direction away from the photosensitive body 10Y to reduce deformation under the non printing condition.

In the developing device according to the embodiment of the invention, therefore, it is preferable that the developing roller 20Y, the developing roller cleaning blade 21Y, and the developer supply roller 32Y contact each other with first contact pressure under the first condition, and that the developing roller 20Y, the developing roller cleaning blade 21Y, and the developer supply roller 32Y contact each other with second contact pressure lower than the first contact pressure under the second condition.

According to the image forming apparatus according to the embodiment of the invention, it is preferable that the developing roller 20Y, the first squeeze roller 13aY, the photosensitive body cleaning blade 18Y, and/or the photosensitive body cleaning roller 16Y contact the photosensitive body 10Y with third contact pressure under the first condition, and that the developing roller 20Y, the first squeeze roller 13aY, the photosensitive body cleaning blade 18Y, and/or the photosensitive body cleaning roller 16Y contact the photosensitive body 10Y with fourth contact pressure lower than the third contact pressure under the second condition.

It is preferable that the photosensitive body 10Y and the developing roller 20Y contact each other with the third contact pressure by the latent image carrier contact member control units such as the swing spring 30bY and the shaft urging spring 3odY to perform image forming process for developing the latent image exposed by the exposing unit 12Y on the photosensitive body 10Y and transferring the developed image to the transfer material such as the intermediate transfer belt 40. After completion of the image formation process, it is preferable that the photosensitive body 10Y and the developing roller 20Y contact each other with the fourth contact pressure lower than the third contact pressure by the latent image carrier contact member control units.

After the driving of the photosensitive body 10Y and the developing roller 20Y stops, it is preferable that the photosensitive body 10Y and the developing roller 20Y contact each other with the fourth contact pressure lower than the third contact pressure by the latent image carrier contact member control units.

It is preferable that the first squeeze roller 13aY contacting the photosensitive body 10Y developed by the developing roller 20Y is provided, and that the photosensitive body 10Y and the first squeeze roller 13aY are positioned away from each other after driving of the photosensitive body 10Y and the developing roller 20Y stops.

In the image forming apparatus according to the embodiment of the invention, it is preferable that the developing roller 20Y and the photosensitive body cleaning blade 18Y contact the photosensitive body 10Y with fifth contact pressure under the first condition, and that the developing roller 20Y and the photosensitive body cleaning blade 18Y contact the photosensitive body 10Y with sixth contact pressure lower than the fifth contact pressure under the second condition.

In the image forming apparatus according to the embodiment of the invention, the first squeeze roller 13aY may be positioned away from the photosensitive body 10Y when the developing roller 20Y contacts the photosensitive body 10Y with low pressure under the third condition. Similarly, the photosensitive body cleaning roller 16Y may be positioned away from the photosensitive body 10Y when the photosensitive body cleaning blade 18Y contacts the photosensitive body 10Y with low pressure. This is because drop of liquid developer can be reduced by the contact of the components disposed below in the vertical direction.

In the developing device and the image forming apparatus according to the embodiment of the invention, the first squeeze roller 13aY and/or the photosensitive body cleaning roller 16Y constitute the latent image carrier contact member, and the developing roller 20Y and/or the photosensitive body cleaning blade 18Y constitute the second latent image carrier contact member.

In the developing device and the image forming apparatus according to the embodiment of the invention, the control unit 30bY and the shaft urging spring 30dY constitute the developer carrier contact control unit.

In the developing device and the image forming apparatus according to the embodiment of the invention, the control unit 30bY, the shaft urging spring 30dY, the developing roller urging spring 20eY, the first squeeze urging spring 13eY, the primary transfer roller urging spring 51eY, the photosensitive body cleaning roller urging spring 16eY, and the photosensitive body cleaning blade urging spring 18dY constitute the latent image carrier contact control unit.

In the developing device and the image forming apparatus according to the embodiment of the invention, the first squeeze lever regulating member 13fY, the photosensitive body cleaning roller lever regulating member 16eY, the photosensitive body cleaning blade regulating member 18eY, and the primary transfer lever regulating member 51fY constitute the latent image carrier contact regulating member.

According to the developing device in this embodiment, drop of liquid developer along the developer carrier toward the components disposed in the gravity direction can be reduced.

According to the developing device in this embodiment, permanent distortion of the developer carrier and concentration unevenness of images can be decreased.

According to the image forming apparatus in this embodiment, drop of liquid developer along the latent image carrier and toward the electrifier and the exposing device disposed in the gravity direction can be reduced. Thus, electrification performance and exposure performance can be maintained.

According to the image forming apparatus in this embodiment, permanent distortion of the latent image carrier contact member and concentration unevenness of images can be decreased.

Japanese Patent Application Nos. 2008-26458 filed on Feb. 6, 2008 and 2008-265947 filed on Oct. 15, 2008 are hereby incorporated by reference in its entirety.

What is claimed is:

1. A developing device comprising:
a developer carrier which carries liquid developer containing toner and carrier liquid;
a developer carrier contact member which contacts the developer carrier; and
a developer carrier contact control unit which controls a condition where the developer carrier and the developer carrier contact member contact each other with first contact pressure and a condition where the developer carrier and the developer carrier contact member contact each other with second contact pressure lower than the first contact pressure.

2. The developing device according to claim 1, wherein the developer carrier contact control unit separates the developer carrier contact member from the developer carrier.

3. The developing device according to claim 1, wherein the developer carrier contact member is a developer carrier cleaning blade which cleans the developer carrier.

4. The developing device according to claim 1, wherein the developer carrier contact member is a developer supply member which supplies the liquid developer to the developer carrier.

5. An image forming apparatus comprising:
a latent image carrier;
an electrifying unit which electrifies the latent image carrier;
an exposing unit which exposes the latent image carrier electrified by the electrifying unit;
a latent image carrier contact member which contacts the latent image carrier; and
a latent image carrier contact control unit which controls a condition where the latent image carrier and the latent image carrier contact member contact each other with first contact pressure and a condition where the latent image carrier and the latent image carrier contact member contact each other with second contact pressure lower than the first contact pressure.

6. The image forming apparatus according to claim 5, further comprising a second latent image carrier contact member disposed below the latent image carrier contact member in a vertical direction.

7. The image forming apparatus according to claim 6, further comprising a second latent image carrier contact control unit which controls a condition where the latent image carrier and the second latent image carrier contact member contact each other with third contact pressure and a condition where the latent image carrier and the second latent image carrier contact member contact each other with fourth contact pressure lower than the third contact pressure.

8. The image forming apparatus according to claim 6, wherein:
the latent image carrier contact member is a squeeze roller which squeezes the latent image carrier; and
the second latent image carrier contact member is a developer carrier which develops the latent image carrier.

9. The image forming apparatus according to claim 5, wherein the latent image carrier contact member is a latent image carrier cleaning roller.

10. The image forming apparatus according to claim 9, wherein the second latent image carrier contact member is a latent image carrier cleaning blade.

11. The image forming apparatus according to claim 5, further comprising a latent image carrier contact regulating member which regulates a position of the latent image carrier contact member at a time of contact with the second contact pressure.

12. The image forming apparatus according to claim 5, wherein the latent image carrier contact control unit is a latent image carrier contact member urging spring which urges the latent image carrier contact member toward the latent image carrier.

13. An image forming method comprising:
bringing a latent image carrier and a developer carrier into contact with each other with first contact pressure by a latent image carrier contact member control unit;
performing image formation process for developing a latent image exposed on the latent image carrier by an exposing unit using the developer carrier and transferring the developed image to a transfer material by contact between the latent image carrier and the developer carrier; and
bringing the latent image carrier and the developer carrier into contact with each other with second contact pressure lower than the first contact pressure by the latent image carrier contact member control unit after completion of the image formation process.

14. The image forming method according to claim 13, wherein the latent image carrier and the developer carrier are brought into contact with each other with the second contact pressure after driving of the latent image carrier and the developer carrier stops.

15. The image forming method according to claim 14, wherein:
a squeeze roller contacting the latent image carrier developed by the developer carrier is provided; and
the latent image carrier is separated from the squeeze roller after driving of the latent image carrier and the developer carrier stops.
